(19) United States
(12) Patent Application Publication
(10) Pub. No.: US 2021/0390483 A1
(43) Pub. Date: Dec. 16, 2021

(54) INTERACTIVE FORECAST MODELING BASED ON VISUALIZATIONS

(71) Applicant: Tableau Software, LLC, Seattle, WA (US)

(72) Inventors: Brian William Nenninger, Cambridge, MA (US); Madeleine Bradley Thompson, Somerville, MA (US); Richard Singleton Tibbetts, Arlington, MA (US); Sarah Elizabetth Wachter, Somerville, MA (US)

(21) Appl. No.: 17/344,633

(22) Filed: Jun. 10, 2021

Related U.S. Application Data
(60) Provisional application No. 63/037,522, filed on Jun. 10, 2020.

(51) Int. Cl. G06Q 10/06; G06F 16/2458

(52) U.S. Cl. CPC G06Q 10/06315; G06F 16/2462

(57) ABSTRACT

Embodiments are directed to embodiments are directed to managing visualizations of data. A visualization based on data from a data source may be provided such that the visualization includes marks that are associated with values from the data source. A prediction query that includes a predicted value field may be provided based on the visualization such that the prediction query may be associated with a prediction model type. Prediction models may be generated based on the prediction model type and the data from the data source that is associated with the marks. Predicted values associated with the predicted value field may be generated using the prediction models. Predicted marks may be generated based on the predicted values such that the predicted marks are included in the visualization. In response to modifications of the visualization, updated prediction models may be generated based on the modification of the visualization.

### CROSS-REFERENCE TO RELATED APPLICATION

This application is a Utility Patent application based on previously filed U.S. Provisional Patent Application No. 63/037,522 filed on Jun. 10, 2020, the benefit of the filing date of which is hereby claimed under 35 U.S.C. § 119(e) and which is further incorporated in entirety by reference.

### TECHNICAL FIELD

The present invention relates generally to data visualization, and more particularly, but not exclusively to, automatically predicting values for use in a visualization.

### BACKGROUND

Organizations are generating and collecting an ever increasing amount of data. This data may be associated with disparate parts of the organization, such as, consumer activity, manufacturing activity, customer service, server logs, or the like. For various reasons, it may be inconvenient for such organizations to effectively utilize their vast collections of data. In some cases the quantity of data may make it difficult to effectively utilize the collected data to improve business practices. In some cases, organizations employ various tools to generate visualizations of the some or all of their data. Employing visualizations to represent this data may enable organizations to improve their understanding of critical business operations and help them monitor key performance indicators. Additionally, organizations may desire to employ their data or visualization to predict values based on the visualization data. Thus, it is with respect to these considerations and others that the present invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 illustrates a schematic embodiment of a client computer;

FIG. 3 illustrates a schematic embodiment of a network computer;

FIG. 4 illustrates a logical architecture of a system for interactive forecast modeling based on visualizations in accordance with one or more of the various embodiments;

FIG. 5 illustrates a logical representation of a portion of a visualization in accordance with one or more of the various embodiments;

FIG. 6 illustrates a logical representation of a portion of a prediction system in accordance with one or more of the various embodiments

FIG. 7 illustrates an overview flowchart of a process for interactive forecast modeling based on visualizations in accordance with one or more of the various embodiments;

FIG. 8 illustrates a flowchart of a process for generating one or more predicted values using prediction models in accordance with one or more of the various embodiments; and

FIG. 9 illustrates a flowchart of a process for generating one or more predicted values using prediction models in accordance with one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C#, or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein, the term “data source” refers to databases, applications, services, file systems, or the like, that store or provide information for an organization. Examples of data sources may include, RDBMS databases, graph databases, spreadsheets, file systems, document management systems, local or remote data streams, or the like. In some cases, data sources are organized around one or more tables or table-like structure. In other cases, data sources be organized as a graph or graph-like structure.

As used herein the term “data model” refers to one or more data structures that provide a representation of an underlying data source. In some cases, data models may provide views of a data source for particular applications. Data models may be considered views or interfaces to the underlying data source. In some cases, data models may map directly to a data source (e.g., practically a logical pass through). Also, in some cases, data models may be provided by a data source. In some circumstances, data models may be considered interfaces to data sources. Data models enable organizations to organize or present information from data sources in ways that may be more convenient, more meaningful (e.g., easier to reason about), safer, or the like.

As used herein the term “data object” refers to one or more entities or data structures that comprise data models. In some cases, data objects may be considered portions of the data model. Data objects may represent individual instances of items or classes or kinds of items.

As used herein the term “panel” refers to region within a graphical user interface (GUI) that has a defined geometry (e.g., x, y, z-order) within the GUI. Panels may be arranged to display information to users or to host one or more interactive controls. The geometry or styles associated with panels may be defined using configuration information, including dynamic rules. Also, in some cases, users may be enabled to perform actions on one or more panels, such as, moving, showing, hiding, re-sizing, re-ordering, or the like.

As user herein the “visualization model” refers to one or more data structures that represent one or more representations of a data model that may be suitable for use in a visualization that is displayed on one or more hardware displays. Visualization models may define styling or user interface features that may be made available to non-authoring user.

As used herein the term “display object” refers to one or more data structures that comprise visualization models. In some cases, display objects may be considered portions of the visualization model. Display objects may represent individual instances of items or entire classes or kinds of items that may be displayed in a visualization. In some embodiments, display objects may be considered or referred to as views because they provide a view of some portion of the data model.

As used herein, the term “mark” refers to a distinct or otherwise identifiable portion of a visualization that may correspond to particular value or result in the visualization. For example, if a visualization includes a bar chart, one or more of the bars may be considered to be marks. Likewise, if a visualization includes a line plot, positions on the plot may be considered a marks.

As used herein, the term “mark-of-interest” refers to a mark in a visualization that has been selected from among the other marks included in the visualization. In some cases, marks in visualizations may incorporate one or more interactive features that may enable a user to select or identify one or more marks-of-interest from among the marks comprising a visualization. For example, a user may be enabled to select a mark-of-interest by right-clicking a mouse button while the mouse pointer may be hovering over a mark. In some cases, marks-of-interest may be selected via searching, filtering, or the like.

As used herein, the term “prediction model” refers to the data structures, data, instructions, or the like, that may be employed to predict values based on various provided inputs. In some cases, prediction models may be generated on demand in response to prediction queries.

As used herein, the term “predicted values” refers to values that may be generated by a prediction model.

At used herein, the term “predicted mark” refers to a mark in a visualization that is based on values predicted by a prediction model.

As used herein the term “configuration information” refers to information that may include rule based policies, pattern matching, scripts (e.g., computer readable instructions), or the like, that may be provided from various sources, including, configuration files, databases, user input, built-in defaults, or the like, or combination thereof.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to managing visualizations of data using one or more processors that execute one or more instructions to perform as described herein.

In one or more of the various embodiments, a visualization based on data from a data source may be provided such that the visualization includes one or more marks that are associated with one or more values from the data source.

In one or more of the various embodiments, a prediction query that includes a predicted value field may be provided based on the visualization such that the prediction query may be associated with a prediction model type. In some embodiments, providing the prediction query may include providing one or more predictors based on one or more fields included in the prediction query such that the one or more predictors correspond to one or more of at least one mark or at least a portion of the data from the data source, and such that the one or more predictors may be employed to generate the one or more prediction models.

In one or more of the various embodiments, one or more prediction models may be generated based on the prediction model type and the data from the data source that is associated with the one or more marks. In some embodiments, generating the one or more prediction models may include executing one or more of linear regression, Gaussian process regression, Bayesian Hierarchical Regression, or the like, based on the prediction model type.

In one or more of the various embodiments, one or more predicted values associated with the predicted value field may be generated using the one or more prediction models such that the one or more predicted values include a predicted quantile value or a probability of an expected value being less than or equal to a value associated with a mark in the visualization. In some embodiments, generating the one or more predicted values may include generating the predicted quantile value based on a posterior distribution of predicted values such that a value corresponding to the predicted quantile is included in the prediction query. In some embodiments, generating the one or more predicted values may include generating a cumulative density function that provides the probability of the expected value being less than or equal to the value associated with the mark in the visualization.

In one or more of the various embodiments, one or more predicted marks may be generated based on the one or more predicted values such that the one or more predicted marks are included in the visualization.

In one or more of the various embodiments, in response to one or more modifications of the visualization, further actions may be performed, including: generating one or more updated prediction models based on the modification of the visualization; generating one or more updated predicted marks based on the one or more updated prediction models such that the one or more updated predicted marks may be included in the modified visualization, or the like.

In one or more of the various embodiments, one or more values from the data from the data source may be determined based on one or more fields included in the prediction query; and the one or more values may be included in the prediction query.

In one or more of the various embodiments, in response to one or more modifications of the data from the data source, performing further actions, including: generating the one or more updated prediction models based on the modification of the data from the data source; generating the one or more updated predicted marks based on the one or more updated prediction models, wherein the one or more updated predicted marks are included in the modified visualization; or the like.

### Illustrated Operating Environment

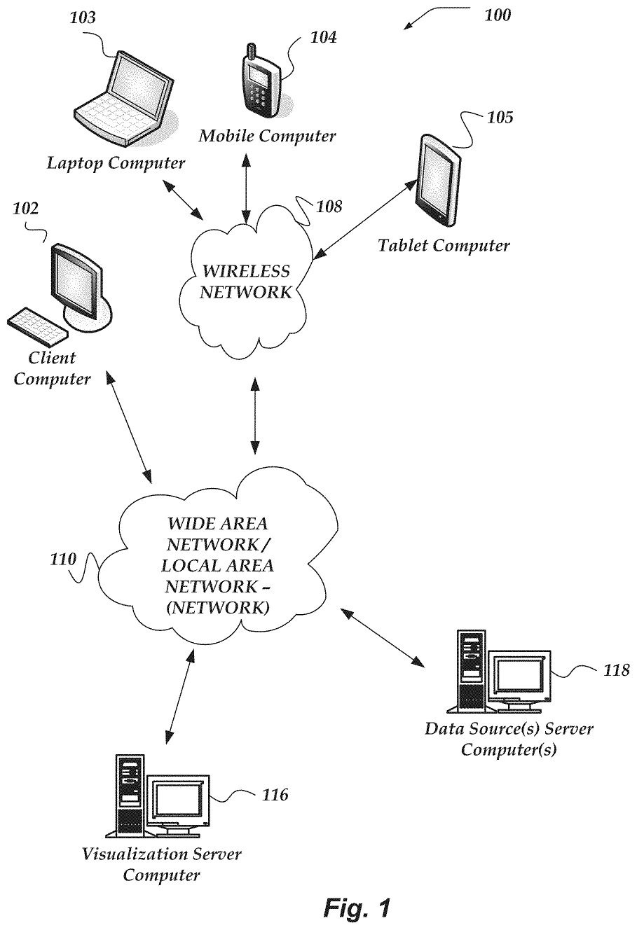

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)-(network) 110, wireless network 108, client computers 102-105, visualization server computer 116, data source server computer 118, or the like.

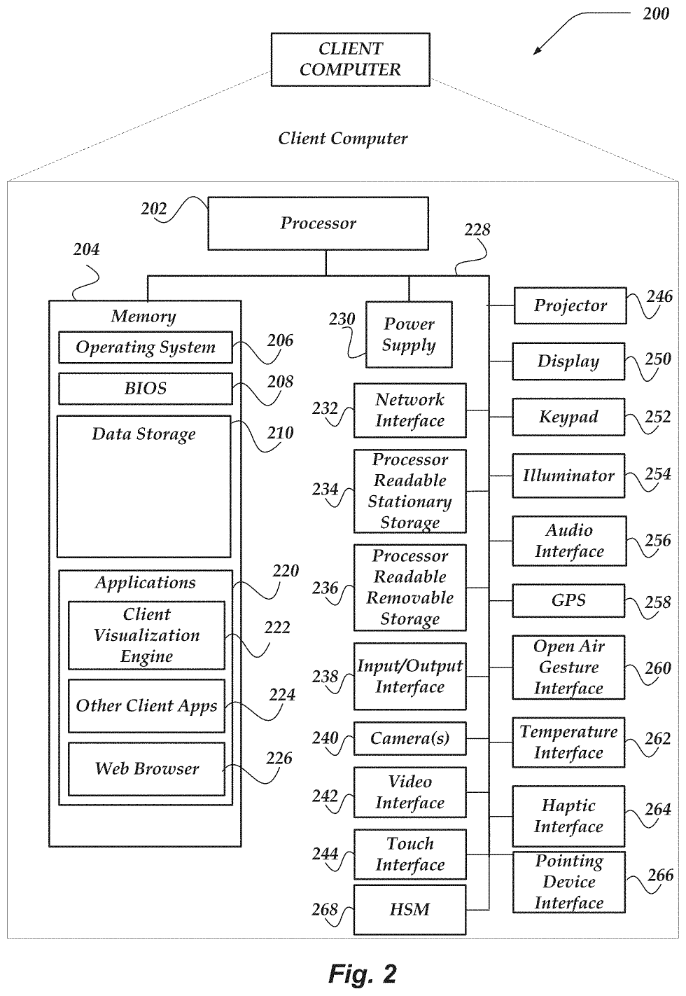

At least one embodiment of client computers 102-105 is described in more detail below in conjunction with FIG. 2. In one embodiment, at least some of client computers 102-105 may operate over one or more wired or wireless networks, such as networks 108, or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), eXtensible Markup Language (XML), JavaScript Object Notation (JSON), Cascading Style Sheets (CS S), or the like, or combination thereof, to display and send a message. In one embodiment, a user of the client computer may employ the browser application to perform various activities over a network (online). However, another application may also be used to perform various online activities.

Client computers 102-105 also may include at least one other client application that is configured to receive or send content between another computer. The client application may include a capability to send or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, visualization server computer 116, data source server computer 118, or other computers.

Client computers 102-105 may further be configured to include a client application that enables an end-user to log into an end-user account that may be managed by another computer, such as visualization server computer 116, data source server computer 118, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by visualization server computer 116, data source server computer 118.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, visualization server computer 116, data source server computer 118, client computers 102, and client computers 103-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

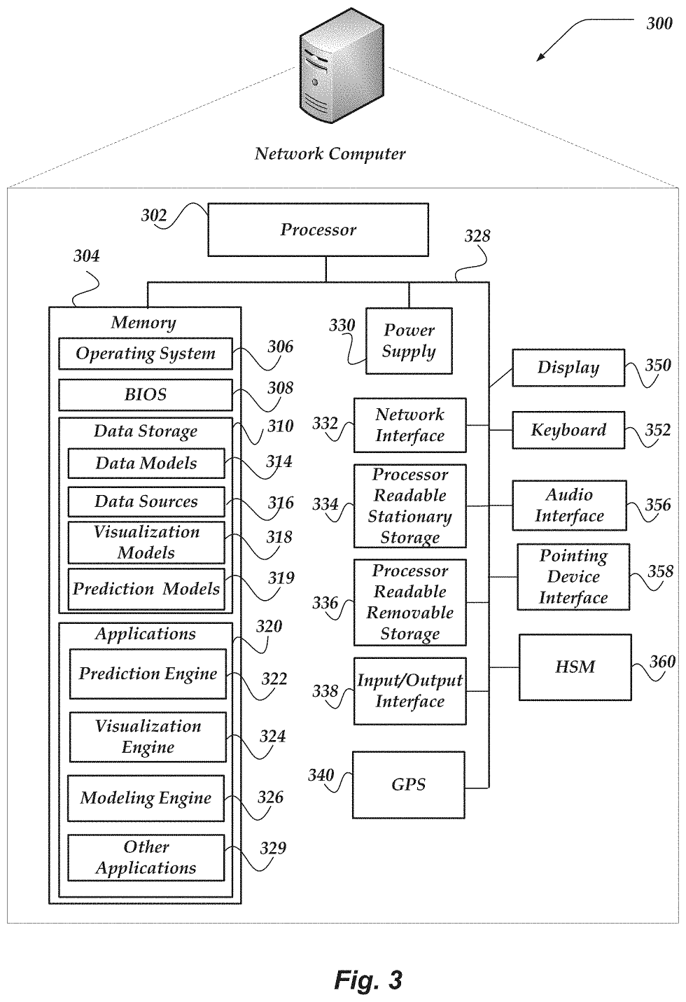

Also, one embodiment of visualization server computer 116, data source server computer 118 are described in more detail below in conjunction with FIG. 3. Although FIG. 1 illustrates visualization server computer 116, data source server computer 118, or the like, each as a single computer, the innovations or embodiments are not so limited. For example, one or more functions of visualization server computer 116, data source server computer 118, or the like, may be distributed across one or more distinct network computers. Moreover, in one or more embodiments, visualization server computer 116, data source server computer 118 may be implemented using a plurality of network computers. Further, in one or more of the various embodiments, visualization server computer 116, data source server computer 118, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 2 shows one embodiment of client computer 200 that may include many more or less components than those shown. Client computer 200 may represent, for example, one or more embodiment of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (MC).

Audio interface 256 may be arranged to produce and receive audio signals such as the sound of a human voice. For example, audio interface 256 may be coupled to a speaker and microphone (not shown) to enable telecommunication with others or generate an audio acknowledgment for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication or provide light. Illuminator 254 may remain active for specific periods of time or in response to event messages. For example, when illuminator 254 is active, it may back-light the buttons on keypad 252 and stay on while the client computer is powered. Also, illuminator 254 may back-light these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In one or more embodiments, however, client computer 200 may, through other components, provide other information that may be employed to determine a physical location of the client computer, including for example, a Media Access Control (MAC) address, IP address, and the like.

In at least one of the various embodiments, applications, such as, operating system 206, other client apps 224, web browser 226, or the like, may be arranged to employ geo-location information to select one or more localization features, such as, time zones, languages, currencies, calendar formatting, or the like. Localization features may be used in display objects, data models, data objects, user-interfaces, reports, as well as internal processes or databases. In at least one of the various embodiments, geo-location information used for selecting localization information may be provided by GPS 258. Also, in some embodiments, geolocation information may include information provided using one or more geolocation protocols over the networks, such as, wireless network 108 or network 111.

Human interface components can be peripheral devices that are physically separate from client computer 200, allowing for remote input or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In one or more embodiments, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX, or LINUX™, or a specialized client computer communication operating system such as Windows Phone™, or the Symbian® operating system. The operating system may include, or interface with a Java virtual machine module that enables control of hardware components or operating system operations via Java application programs.

Memory 204 may further include one or more data storage 210, which can be utilized by client computer 200 to store, among other things, applications 220 or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, or otherwise process instructions and data. Applications 220 may include, for example, client visualization engine 222, other client applications 224, web browser 226, or the like. Client computers may be arranged to exchange communications one or more servers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, visualization applications, and so forth.

Additionally, in one or more embodiments (not shown in the figures), client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 200 may include one or more hardware micro-controllers instead of CPUs. In one or more embodiments, the one or more micro-controllers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 3 shows one embodiment of network computer 300 that may be included in a system implementing one or more of the various embodiments. Network computer 300 may include many more or less components than those shown in FIG. 3. However, the components shown are sufficient to disclose an illustrative embodiment for practicing these innovations. Network computer 300 may represent, for example, one embodiment of at least one of visualization server computer 116, data source server computer 118, or the like, of FIG. 1.

Network computers, such as, network computer 300 may include a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others or generate an audio acknowledgment for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. In some embodiments, display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 300. Human interface components can be physically separate from network computer 300, allowing for remote input or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In one or more embodiments, however, network computer 300 may, through other components, provide other information that may be employed to determine a physical location of the client computer, including for example, a Media Access Control (MAC) address, IP address, and the like.

In at least one of the various embodiments, applications, such as, operating system 306, prediction engine 322, visualization engine 324, modeling engine 326, other applications 329, or the like, may be arranged to employ geo-location information to select one or more localization features, such as, time zones, languages, currencies, currency formatting, calendar formatting, or the like. Localization features may be used in user interfaces, dashboards, visualizations, reports, visualization marks, as well as internal processes or databases. In at least one of the various embodiments, geo-location information used for selecting localization information may be provided by GPS 340. Also, in some embodiments, geolocation information may include information provided using one or more geolocation protocols over the networks, such as, wireless network 108 or network 111.

Memory 304 may include Random Access Memory (RAM), Read-Only Memory (ROM), or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of network computer 300. The memory also stores an operating system 306 for controlling the operation of network computer 300. It will be appreciated that this component may include a general-purpose operating system such as a version of UNIX, or LINUX™, or a specialized operating system such as Microsoft Corporation's Windows® operating system, or the Apple Corporation's OSX® operating system. The operating system may include, or interface with one or more virtual machine modules, such as, a Java virtual machine module that enables control of hardware components or operating system operations via Java application programs. Likewise, other runtime environments may be included.

Memory 304 may further include one or more data storage 310, which can be utilized by network computer 300 to store, among other things, applications 320 or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, data models 314, data sources 316, visualization models 318, prediction models 319, or the like.

Applications 320 may include computer executable instructions which, when executed by network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include prediction engine 322, visualization engine 324, modeling engine 326, other applications 329, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, prediction engine 322, visualization engine 324, modeling engine 326, other applications 329, or the like, may be operative in a cloud-based computing environment. In one or more of the various embodiments, these applications, and others, that comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to prediction engine 322, visualization engine 324, modeling engine 326, other applications 329, or the like, may be provisioned and de-commissioned automatically.

Also, in one or more of the various embodiments, prediction engine 322, visualization engine 324, modeling engine 326, other applications 329, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiments, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

### Illustrative Logical System Architecture

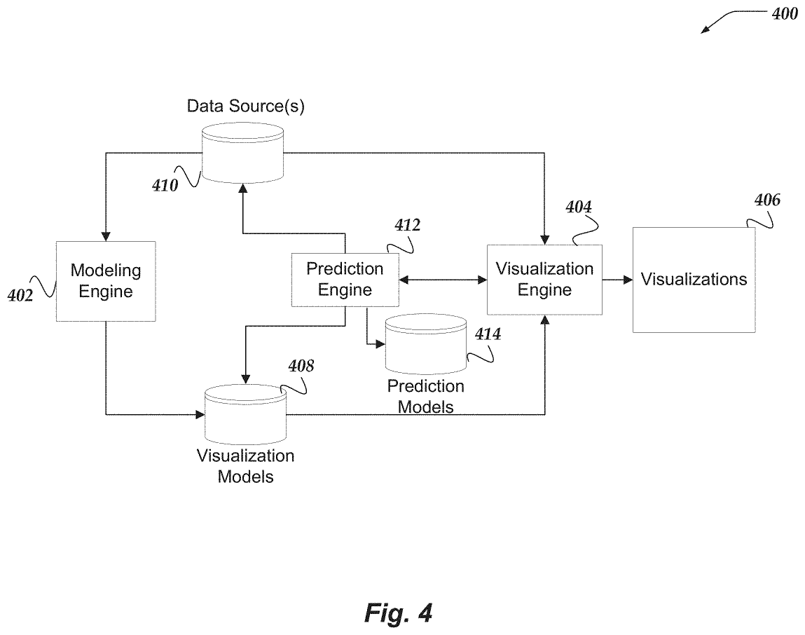

FIG. 4 illustrates a logical architecture of system 400 for interactive forecast modeling based on visualizations in accordance with one or more of the various embodiments. In one or more of the various embodiments, system 400 may be comprised of various components, including, one or more modeling engines, such as, modeling engine 402; one or more visualization engines, such as, visualization engine 404; one or more visualizations, such as, visualization 406; one or more data sources, such as, data source 410; one or more visualization models, such as, visualization model 408; one or more prediction engines, such as, prediction engine 412; or one or more prediction models, such as, prediction models 414.

In one or more of the various embodiments, modeling engine 402 may be arranged to enable users to design one or more visualization models that may be provided to visualization engine 404. Accordingly, in one or more of the various embodiments, visualization engine 404 may be arranged to generate one or more visualizations based on the visualization models.

In one or more of the various embodiments, modeling engines may be arranged to access one or more data sources, such as, data source 410. In some embodiments, modeling engines may be arranged to include user interfaces that enable users to browse various data source information, data objects, or the like, to design visualization models that may be used to generate visualizations of the information stored in the data sources.

Accordingly, in some embodiments, visualization models may be designed to provide visualizations that include charts, plots, graphs, tables, graphics, styling, explanatory text, interactive elements, user interface features, or the like. In some embodiments, users may be provided a graphical user interface that enables them to interactively design visualization models such that various elements or display objects in the visualization model may be associated with data from one or more data sources, such as, data source 410.

In one or more of the various embodiments, data sources, such as, data source 410 may include one or more of databases, data stores, file systems, or the like, that may be located locally or remotely. In some embodiments, data sources may be provided by another service over a network. In some embodiments, there may be one or more components (not shown) that filter or otherwise provide management views or administrative access to the data in a data source.

In one or more of the various embodiments, visualization models may be stored in one or more data stores, such as, visualization model storage 408. In this example, for some embodiments, visualization model storage 408 represents one or more databases, file systems, or the like, for storing, securing, or indexing visualization models.

In one or more of the various embodiments, visualization engines, such as, visualization engine 404 may be arranged to parse or otherwise interpret the visualization models and data from data sources to generate one or more visualizations that may be displayed to users.

In one or more of the various embodiments, prediction engines, such as, prediction engine 412 may be arranged to generate prediction information based on the marks in a visualization, the data associated with the visualization, or the like. Prediction information, such as, predicted values, predicted marks, or the like. Prediction information may include values associated with a particular prediction or prediction type. Accordingly, in some embodiments, prediction engines may be arranged to automatically provide statistical based prediction values associated with the visualization. In some embodiments, prediction engines may be arranged to automatically pull in additional data from the data source associated with a visualization to employ if prediction values are requested. In one or more of the various embodiments, prediction values may be employed to generate one or more prediction marks that may be included in the visualization.

In one or more of the various embodiments, prediction engines may be arranged to automatically generate one or more prediction models, such as, prediction models 414. Prediction models may be generated based on the visualizations, data source data, one or more marks in the visualization, or the like.

In some embodiments, prediction engines may be arranged to generate prediction models based on one or more prediction parameters included in prediction queries provided to the prediction engine. In some embodiments, the visualization model may be arranged to automatically provide particular information the prediction engine for use in generating prediction models. For example, one or more values or marks associated with visualization 404 may be automatically included prediction queries.

In one or more of the various embodiments, prediction engines may enable users to generate one or more predicted values or predicted marks that may be displayed in a visualization. Accordingly, in some embodiments, visualization engines may be arranged to generate visualizations that include interactive user interface features that enable a user to select one or more marks-of-interest.

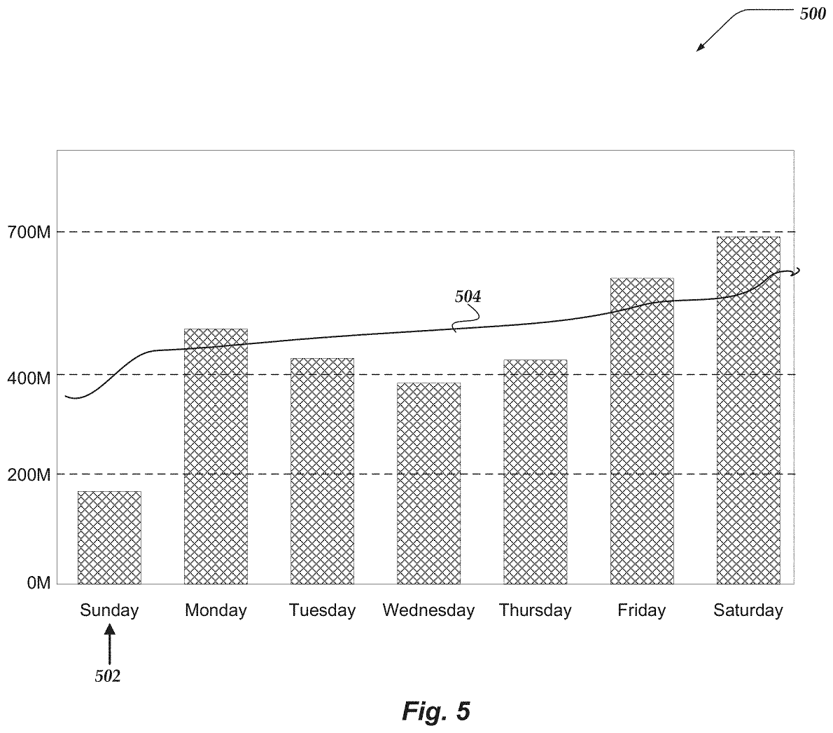

FIG. 5 illustrates a logical representation of a portion of visualization 500 in accordance with one or more of the various embodiments. As described above, visualization engines may be arranged to employ visualization models and data to generate visualizations, such as, visualization 500. In this example, visualization 500 represents a bar chart that shows sales revenue per day-of-week. One of ordinary skill in the art will appreciate that visualization models or visualization engines may be arranged to generate many different types of visualizations for various purposes depending on the design goals of users or organizations. Here, visualization 500 is presented as a non-limiting example to help provide clarity to the description of these innovations. One of ordinary skill in the art will appreciate that this example is at least sufficient to disclose the innovations herein and that visualization engines or visualization models may be arranged to generate many different visualizations for many different purposes in many domains.

In this example, mark 502 that represents the revenue earned on Sunday.

In one or more of the various embodiments, visualization models or visualizations may be configured to include one or more visualization features that may be based on predicted values. In this example, line 504 may be a visualization feature that represents the predicted revenue. Accordingly, in this example, line 504 may be based on predicted values generated by one or more prediction models. Thus, in this non-limiting example, visualization 500 enables users to rapidly compare the predicted revenue value with the actual values represented by bars, such as, mark 502.

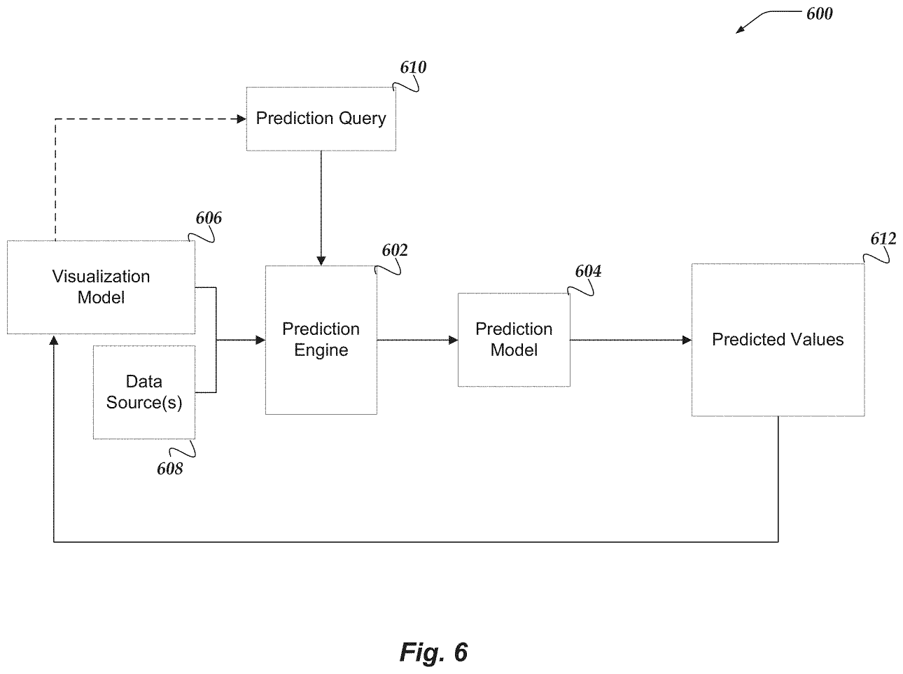

FIG. 6 illustrates a logical representation of a portion of prediction system 600 in accordance with one or more of the various embodiments. In one or more of the various embodiments, system 600 may include one or more components, such as, assessment engine 602, prediction model 604, visualization model 606, data source 608, prediction query 610, one or more predicted values or predicted marks, such as, predicted values 612, or the like.

In one or more of the various embodiments, prediction engine 602 may be arranged to employ one or more prediction queries, such as, prediction query 610 to determine one or more fields (e.g., values, marks, or the like) or one or more prediction model types that may be employed to generate prediction models, such as, prediction model 604. In one or more of the various embodiments, prediction models may be arranged to include one or more heuristics, machine-learning evaluators, statistic based evaluators that may be executed to provide prediction values or prediction marks based on the prediction query 610.

In one or more of the various embodiments, prediction engine 602 may be arranged to generate prediction models on demand to provide prediction models that may be designed or tailored to evaluate one or more statistical features of a values, fields, or marks referenced or included in prediction query 610.

In one or more of the various embodiments, predicted value 612 may be provided back to visualization model 606 to enable a visualization engine (not shown) to update a visualization based on the predicted values.

In some embodiments, inputs or components of prediction query 610 may be provided or referenced directly from a visualization model, such as, visualization model 606.

### Generalized Operations

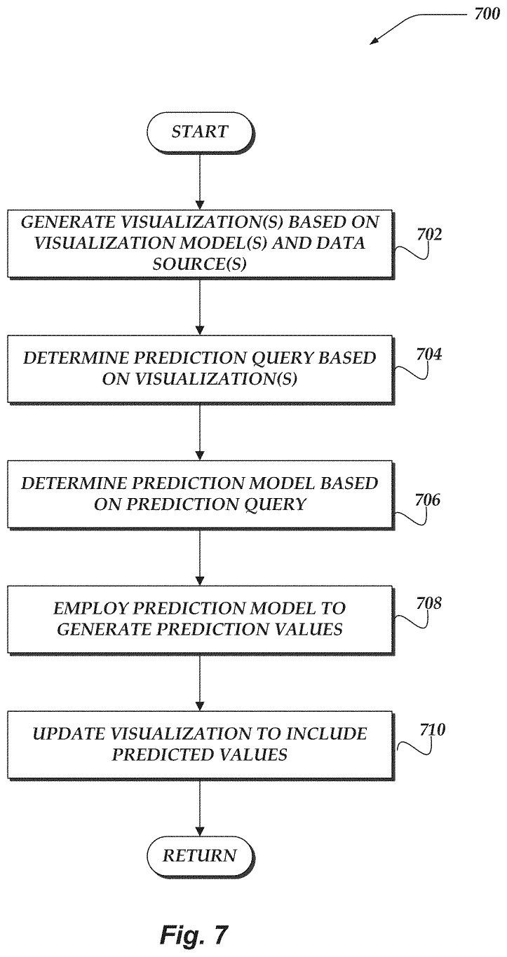

FIGS. 7-9 represent generalized operations for interactive forecast modeling based on visualizations in accordance with one or more of the various embodiments. In one or more of the various embodiments, processes 700, 800, and 900 described in conjunction with FIGS. 7-9 may be implemented by or executed by one or more processors on a single network computer (or network monitoring computer), such as network computer 300 of FIG. 3. In other embodiments, these processes, or portions thereof, may be implemented by or executed on a plurality of network computers, such as network computer 300 of FIG. 3. In yet other embodiments, these processes, or portions thereof, may be implemented by or executed on one or more virtualized computers, such as, those in a cloud-based environment. However, embodiments are not so limited and various combinations of network computers, client computers, or the like may be utilized. Further, in one or more of the various embodiments, the processes described in conjunction with FIGS. 7-9 may be used for analyzing marks in visualizations based on data characteristics in accordance with at least one of the various embodiments or architectures such as those described in conjunction with FIGS. 4-6. Further, in one or more of the various embodiments, some or all of the actions performed by processes 700, 800, and 900 may be executed in part by prediction engine 322, visualization engine 324, modeling engine 326 one or more processors of one or more network computers.

FIG. 7 illustrates an overview flowchart for process 700 for interactive forecast modeling based on visualizations in accordance with one or more of the various embodiments. After a start block, at block 702, in one or more of the various embodiments, a visualization engine may be arranged to generate one or more visualizations based on one or more visualization models or data sources. As described above, a visualization system may be arranged to include, one or more modeling engines, one or more data sources, one or more visualization engines, or the like, that may be arranged to generate visualizations based on one or more visualization models and data provided by the one or more data sources.

At block 704, in one or more of the various embodiments, a prediction engine may be arranged to determine one or more prediction queries based on one or more visualizations. In one or more of the various embodiments, prediction queries associated with a visualization may be automatically provided to the prediction engine. For example, visualization models may be designed to link or bind prediction queries with one or more marks, or other visualization features defined in a visualization model.

At block 706, in one or more of the various embodiments, the prediction engine may be arranged to determine a prediction model based on the prediction query. In some embodiments, prediction engines may be arranged to generate prediction models on-the-fly based on fields, marks-of-interest, or the like, included in the prediction query. In some embodiments, other information, such as, data from data sources, may be employed to generate prediction models. Or, similarly, in some embodiments, data associated with the one or more marks-of-interest may be employed to generate one or more prediction models.

At block 708, in one or more of the various embodiments, the prediction engine may be arranged to employ the prediction model to generate one or more prediction values based on the one or more prediction models. In one or more of the various embodiments, prediction engines may be arranged to execute one or more prediction models to evaluate the one or more field values provided with the prediction query to generate prediction information based on underlying data/data-source associated with the marks-of-interest. In some embodiments, fields or data provided to prediction engines may be identified using labels or other identifiers associated with the data source or the visualization, such as, row labels, column labels, or the like.

At block 708, in one or more of the various embodiments, the prediction engine may be arranged to generate one or more predicted values based on the prediction information.

At block 710, in one or more of the various embodiments, the visualization engine may be arranged to display one or more of the predicted values in the visualization. In some embodiments, visualization engines may be arranged to automatically update one or more marks based on one or more predicted values provided by the prediction engine.

In one or more of the various embodiments, as the data underlying a visualization changes, prediction engines may be configured to automatically execute prediction queries to provided updated predicted value based on the prediction models and the updated data.

Next, in one or more of the various embodiments, control may be returned to a calling process.

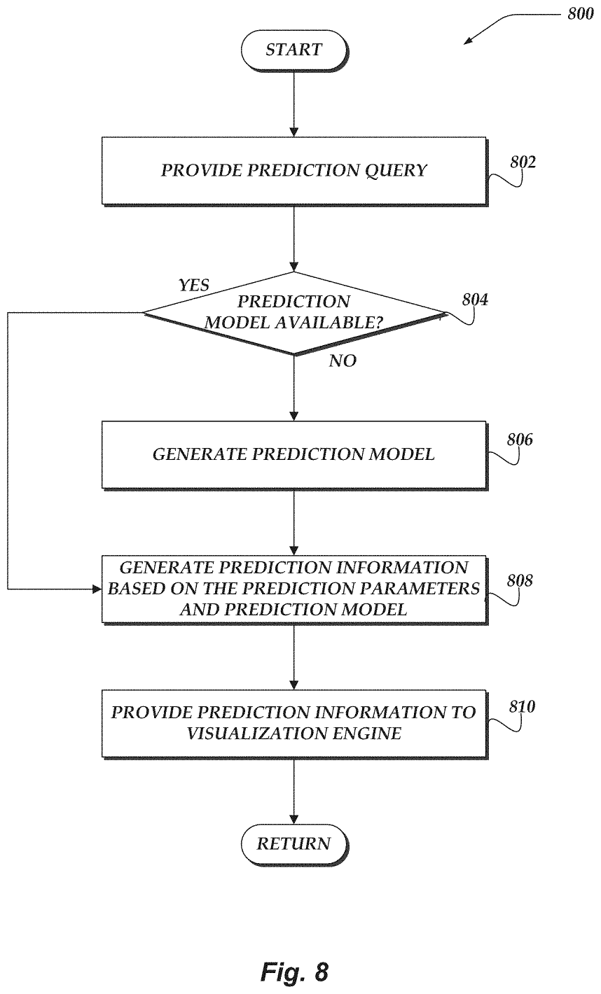

FIG. 8 illustrates a flowchart of process 800 for generating one or more predicted values using prediction models in accordance with one or more of the various embodiments. After a start block, at block 802, in one or more of the various embodiments, a prediction query that includes various prediction parameters may be provided to the prediction engine. In some embodiments, prediction parameters may include one or more of, one or more marks or mark identifiers, one or more data source identifiers, or the like. Also, in some embodiments, prediction parameters may include an indicator or identifier that corresponds to a particular prediction model. Further, in some embodiments, one or more particular prediction models may require one or more specific parameters. In some embodiments, visualization models or visualizations may be arranged to be associated with one or more prediction models that may be determined based on the required prediction parameters.

In some embodiments, one or more prediction parameters may be selected by a user employing an interactive user interface. Also, in some embodiments, one or more prediction parameters may be automatically provided based on the visualization model associated with the visualization. In some embodiments, a visualization author or creator may create a visualization model that includes specific visualization features that provide prediction parameters to the prediction engine. For example, a visualization model may include features for automatically generating visualizations associated with predicted values or predicted marks. Accordingly, such features may include binding or linking visualization marks or data source values to one or more prediction parameters.

Further, in some embodiments, prediction parameters may include some or all of data employed by the prediction engine to generate prediction models, such as, one or more rows, one or more tables, one or more sets, or the like, of values used for generating prediction model. In some embodiments, the prediction query may explicitly include the data values. However, in some embodiments, a prediction query may include one or more labels, or the like, that correspond to data used in the visualization. Accordingly, in some embodiments, the prediction engine may be arranged to obtain the values that correspond to the provided labels, from the visualization model, data sources, or the like.

At decision block 804, in one or more of the various embodiments, if a prediction model that corresponds to the prediction parameters may be available, control may flow to block 808; otherwise, control may flow to block 806.

As described above, in one or more of the various embodiments, prediction engines may be arranged to generate prediction models on-demand. However, in some embodiments, prediction engines may be arranged to maintain or persist one or more prediction models until one or more conditions may be met, such as, one or more prediction models may be persisted for a defined duration, the duration of a activity session, or the like. For example, for some embodiments, prediction models generated while a user is interacting with a visualization may be persisted until the user ends the session. Similarly, in some embodiments, other persistence schemes may be employed, such as, employing model caches or model pools, that execute various cache management schemes. Accordingly, in some embodiments, prediction engines may be arranged to employ rules, instructions, or the like, provided via configuration information to determine persistence behavior of the generated prediction models. Thus, depending on the visualization, prediction queries, prediction model caching scheme, or the like, a prediction model may be available. Otherwise, prediction engines may be arranged to generate a prediction model for the prediction query on demand.

At block 806, in one or more of the various embodiments, the prediction engine may be arranged to generate a prediction model based on the prediction information.

In one or more of the various embodiments, prediction engine may be arranged to generate a prediction model based on the prediction parameters. For example, in some embodiments, the prediction engine may be arranged to generate prediction models tailored to match the visualization, data source, one or more of the prediction parameters, or the like. Also, in some embodiments, the prediction models may be composed of more than one model. For example, a base prediction model may provide data structures, interfaces, rules, instructions, or the like, that may host or contain a generated prediction model (or sub-model) that may be based on the prediction parameters, the visualization, the underlying data source, or the like.

In one or more of the various embodiments, prediction engines may be arranged to determine a prediction model type based on the prediction parameters. In some embodiments, the prediction model type may be expressly provided with the prediction query. In other embodiments, the prediction engine may be arranged to infer a prediction model type from the prediction parameters. Accordingly, in some embodiments, prediction engines may be arranged to employ mapping rules, or the like, provided via configuration information to determine a prediction model type from prediction parameters.

In one or more of the various embodiments, one or more prediction models may be generated based on the prediction model type and the data from the data source that is associated with the one or more marks. In some embodiments, generating the one or more prediction models may include executing one or more of linear regression, Gaussian process regression, Bayesian Hierarchical Regression, or the like, based on the prediction model type.

In one or more of the various embodiments, one or more predicted values associated with the predicted value field may be generated using the one or more prediction models such that the one or more predicted values include a predicted quantile value or a probability of an expected value being less than or equal to a value associated with a mark in the visualization. In some embodiments, generating the one or more predicted values may include generating the predicted quantile value based on a posterior distribution of predicted values such that a value corresponding to the predicted quantile is included in the prediction query. In some embodiments, generating the one or more predicted values may include generating a cumulative density function that provides the probability of the expected value being less than or equal to the value associated with the mark in the visualization.

At block 808, in one or more of the various embodiments, the prediction engine may be arranged to generate prediction information based on the prediction parameters and the prediction model. In some embodiments, the particular prediction information may vary depending on the prediction query or the prediction model. For example, in some embodiments, a prediction query that requests a predicted value may result in prediction information that includes a predicted value. Further, in some embodiments, prediction queries may include parameters or instructions that a prediction engine may interpret to format the prediction information.

In one or more of the various embodiments, one or more of the prediction parameters included in the prediction query may be an identifier associated with the one or more marks or values that may be predicted by the prediction model. In some embodiments, the specific context or meaning of a predicted value may depend on the prediction query or the prediction model. For example, in some cases, prediction queries may request a predicted value. Similarly, in some embodiments, other prediction queries may request a value that represents one or more qualities or characteristics of the mark, such as, its quartile, or the like.

Next, in one or more of the various embodiments, control may be returned to a calling process.

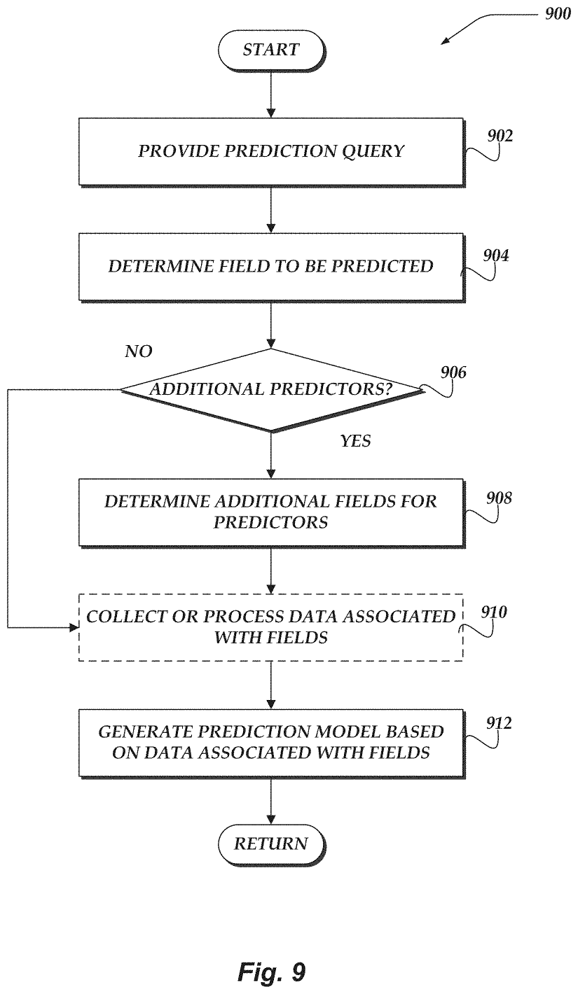

FIG. 9 illustrates a flowchart of process 900 for generating one or more predicted values using prediction models in accordance with one or more of the various embodiments. After a start block, at block 902, in one or more of the various embodiments, as described above, a prediction query that includes various prediction parameters may be provided to the prediction engine. In one or more of the various embodiments, one or more prediction parameters included in the prediction query may be expressly or implicitly reference a field that corresponds to a field in a data source, one or more marks in the visualization, or the like.

At block 904, in one or more of the various embodiments, the prediction engine may be arranged to determine one or more fields in the query that may be predicted. In one or more of the various embodiments, the various fields in the prediction query may be determined based on explicit labels or names. Also, in some embodiments, one or more fields may be determined based on their position or order in the prediction query. Further, in some embodiments, one or more fields may be generated or determined based on defaulting rules associated with prediction query or a prediction model type referenced by the prediction query.

In one or more of the various embodiments, the fields corresponding to the values being predicted may correspond to a mark or other feature in the visualization.

At decision block 906, in one or more of the various embodiments, if there may be additional predictors in the prediction query, control may flow to block 908; otherwise, control flow to block 910. In one or more of the various embodiments,

In one or more of the various embodiments, predictors may be independent variables that may be included in the generation of some prediction models. Accordingly, in one or more of the various embodiments, the field associated with the requested predicted value may automatically be considered a predictor. Thus, each prediction query implicitly provides at least one predictor. Also, in one or more of the various embodiments, depending on the prediction query or prediction model type, additional predictors may be indicated in the prediction query by one or more prediction parameters. For example, if a prediction query is provided to predict the expected price of a product, it may include additional predictors, such as, cost of goods, shipping cost, size or weight, or the like, that may be employed to generate a prediction model that predicts prices for products.

In one or more of the various embodiments, the format or data types of predictors may vary depending on the type of prediction model being generated. Accordingly, in one or more of the various embodiments, other information in the prediction query, such as, prediction model type indicators, or the like, may be employed to validate that the necessary predictors have been identified. In some embodiments, prediction engines may be arranged to determine the rules or instructions for validating predictors based on configuration information to account for local circumstances or local requirements.

At block 908, in one or more of the various embodiments, the prediction engine may be arranged to determine one or more additional fields that may be employed as predictors. In some embodiments, one or more additional fields that may correspond to visualization marks, fields in data sources associated with the visualization, or the like, may be identified or labeled in the prediction query. Further, in some embodiments, the query may include one or more labels that may be associated with more than one field. Thus, in such cases, the prediction engine may be arranged to interpret, de-reference, or expand the label to provide or identify one or more fields representing predictors.

At block 910, in one or more of the various embodiments, optionally, the prediction engine may be arranged to collect or process the data or data sets associated with the fields determined from the prediction query. In some embodiments, prediction engine may be arranged to employ one or more of the field identifiers to obtain the data that correspond to the fields. In some embodiments, the data may be obtained from the visualization model or data sources associated with a visualization. Also, in some embodiments, the data may be retrieved from another source, such as, an external database or external service.

Further, in some embodiments, fields may be associated with one or more pre-processing functions that require the data values to be manipulated, normalized, aggregated, transformed, or the like, before being employed to generate prediction models.

Also, in one or more of the various embodiments, one or more prediction model types may require the data to fit within various constraints or conditions. Accordingly, in some embodiments, prediction engine automatically process the data to meet the requirements of the prediction model type.

Further, in some embodiments, fields in a prediction query may be associated with a filter that excludes some data based on various characteristics. Similarly, one or more one or more prediction model types may require data that is filtered to exclude some data values that may be incompatible with a given prediction model type.

In some embodiments, prediction engines may be arranged to employ configuration information to define one or more functions, filters, or the like, that may be available for including in prediction queries.

Note, this block is marked optional, because in some embodiments, the prediction query may include the data or data sets that may be used generating the prediction models. In some cases, the provided data or data sets may be processed before they are provided to the prediction engine.

At block 912, in one or more of the various embodiments, the prediction engine may be arranged to generate a prediction model based on the data or data sets associated with the fields included or determined from the prediction query.

In one or more of the various embodiments, prediction engines may be arranged to perform various actions, such as, sampling, curve fitting, or the like, to generate prediction models. In some embodiments, the instructions or rules associated with prediction model types may determine the particular actions that a prediction engine may perform. In one or more of the various embodiments, prediction engines may employ instructions provided via configuration information to determine the specific actions to perform. Thus, in one or more of the various embodiments, the actions associated with different prediction model types may be configured to account for local requirements or local circumstances, including the availability of one or more prediction model types.

Next, in one or more of the various embodiments, control may be returned to a calling process.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware-based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

What is claimed as new and desired to be protected by Letters Patent of the United States is:

1. A method for managing visualizations of data using one or more processors that execute instructions to perform actions, comprising:
providing a visualization based on data from a data source, wherein
the visualization includes one or more marks that are associated
with one or more values from the data source;
providing a prediction query that includes a predicted value field based on the visualization, wherein the prediction query is associated with a prediction model type;
generating one or more prediction models based on the prediction model type and the data from the data source that is associated with the one or more marks;
generating one or more predicted values associated with the predicted value field using the one or more prediction models, wherein the one or more predicted values include a predicted quantile value or a probability of an expected value being less than or equal to a value associated with a mark in the visualization;
generating one or more predicted marks based on the one or more predicted values, wherein the one or more predicted marks are included in the visualization; and
in response to one or more modifications of the visualization, performing further actions, including:
generating one or more updated prediction models based on the modification of the visualization; and
generating one or more updated predicted marks based on the one or more updated prediction models, wherein the one or more updated predicted marks are included in the modified visualization.

2. The method of claim 1, wherein providing the prediction query, further includes, providing one or more predictors based on one or more fields included in the prediction query, wherein the one or more predictors correspond to one or more of at least one mark or at least a portion of the data from the data source, and wherein the one or more predictors are employed to generate the one or more prediction models.

3. The method of claim 1, wherein generating the one or more prediction models, further comprises, executing one or more of linear regression, Gaussian process regression, or Bayesian Hierarchical Regression based on the prediction model type.

4. The method of claim 1, further comprising:
determining one or more values from the data from the data source based on one or more fields included in the prediction query; and
including the one or more values in the prediction query.

5. The method of claim 1, wherein generating the one or more predicted values, further comprises, generating the predicted quantile value based on a posterior distribution of predicted values, wherein a value corresponding to the predicted quantile is included in the prediction query.

6. The method of claim 1, wherein generating the one or more predicted values, further comprises, generating a cumulative density function that provides the probability of the expected value being less than or equal to the value associated with the mark in the visualization.

7. The method of claim 1, further comprising:
in response to one or more modifications of the data from the data source, performing further actions, including:
generating the one or more updated prediction models based on the modification of the data from the data source; and
generating the one or more updated predicted marks based on the one or more updated prediction models, wherein the one or more updated predicted marks are included in the modified visualization.

8. A processor readable non-transitory storage media that includes instructions for managing visualizations, wherein execution of the instructions by one or more processors, performs actions, comprising:
providing a visualization based on data from a data source, wherein
the visualization includes one or more marks that are associated
with one or more values from the data source;
providing a prediction query that includes a predicted value field based on the visualization, wherein the prediction query is associated with a prediction model type;
generating one or more prediction models based on the prediction model type and the data from the data source that is associated with the one or more marks;
generating one or more predicted values associated with the predicted value field using the one or more prediction models, wherein the one or more predicted values include a predicted quantile value or a probability of an expected value being less than or equal to a value associated with a mark in the visualization;
generating one or more predicted marks based on the one or more predicted values, wherein the one or more predicted marks are included in the visualization; and
in response to one or more modifications of the visualization, performing further actions, including:
generating one or more updated prediction models based on the modification of the visualization; and
generating one or more updated predicted marks based on the one or more updated prediction models, wherein the one or more updated predicted marks are included in the modified visualization.

9. The media of claim 8, wherein providing the prediction query, further includes, providing one or more predictors based on one or more fields included in the prediction query, wherein the one or more predictors correspond to one or more of at least one mark or at least a portion of the data from the data source, and wherein the one or more predictors are employed to generate the one or more prediction models.

10. The media of claim 8, wherein generating the one or more prediction models, further comprises, executing one or more of linear regression, Gaussian process regression, or Bayesian Hierarchical Regression based on the prediction model type.

11. The media of claim 8, further comprising:
determining one or more values from the data from the data source based on one or more fields included in the prediction query; and
including the one or more values in the prediction query.

12. The media of claim 8, wherein generating the one or more predicted values, further comprises, generating the predicted quantile value based on a posterior distribution of predicted values, wherein a value corresponding to the predicted quantile is included in the prediction query.

13. The media of claim 8, wherein generating the one or more predicted values, further comprises, generating a cumulative density function that provides the probability of the expected value being less than or equal to the value associated with the mark in the visualization.

14. The media of claim 8, further comprising:
in response to one or more modifications of the data from the data source, performing further actions, including:
generating the one or more updated prediction models based on the modification of the data from the data source; and
generating the one or more updated predicted marks based on the one or more updated prediction models, wherein the one or more updated predicted marks are included in the modified visualization.

15. A system for managing visualizations, comprising:
a network computer, comprising:
a transceiver that communicates over the network;
a memory that stores at least instructions; and
one or more processors that execute instructions that perform actions, including:
providing a visualization based on data from a data source, wherein
the visualization includes one or more marks that are associated
with one or more values from the data source;
providing a prediction query that includes a predicted value field based on the visualization, wherein the prediction query is associated with a prediction model type;
generating one or more prediction models based on the prediction model type and the data from the data source that is associated with the one or more marks;
generating one or more predicted values associated with the predicted value field using the one or more prediction models, wherein the one or more predicted values include a predicted quantile value or a probability of an expected value being less than or equal to a value associated with a mark in the visualization;
generating one or more predicted marks based on the one or more predicted values, wherein the one or more predicted marks are included in the visualization; and
in response to one or more modifications of the visualization, performing further actions, including:
generating one or more updated prediction models based on the modification of the visualization; and
generating one or more updated predicted marks based on the one or more updated prediction models, wherein the one or more updated predicted marks are included in the modified visualization; and
a client computer, comprising:
a transceiver that communicates over the network;
a memory that stores at least instructions; and
one or more processors that execute instructions that perform actions, including:
displaying the visualization on a hardware display.

16. The system of claim 15, wherein providing the prediction query, further includes, providing one or more predictors based on one or more fields included in the prediction query, wherein the one or more predictors correspond to one or more of at least one mark or at least a portion of the data from the data source, and wherein the one or more predictors are employed to generate the one or more prediction models.

17. The system of claim 15, wherein generating the one or more prediction models, further comprises, executing one or more of linear regression, Gaussian process regression, or Bayesian Hierarchical Regression based on the prediction model type.

18. The system of claim 15, wherein the one or more processors of the network computer execute instructions that perform actions, further comprising:
determining one or more values from the data from the data source based on one or more fields included in the prediction query; and
including the one or more values in the prediction query.

19. The system of claim 15, wherein generating the one or more predicted values, further comprises, generating a cumulative density function that provides the probability of the expected value being less than or equal to the value associated with the mark in the visualization.

20. The system of claim 15, wherein the one or more processors of the network computer execute instructions that perform actions, further comprising:
in response to one or more modifications of the data from the data source, performing further actions, including:
generating the one or more updated prediction models based on the modification of the data from the data source; and
generating the one or more updated predicted marks based on the one or more updated prediction models, wherein the one or more updated predicted marks are included in the modified visualization.
